(19) United States
(12) Patent Application Publication
(10) Pub. No.: US 2020/0334103 A1
(43) Pub. Date: Oct. 22, 2020

(54) STORAGE SYSTEM, DRIVE HOUSING THEREOF, AND PARITY CALCULATION METHOD

(71) Applicant: Hitachi, Ltd., Tokyo (JP)

(72) Inventors: Yuya MIYOSHI, Tokyo (JP); Takashi NODA, Tokyo (JP)

(21) Appl. No.: 16/793,051

(22) Filed: Feb. 18, 2020

(30) Foreign Application Priority Data
Apr. 19, 2019 (JP) 2019-080051

(51) Int. Cl. G06F 11/10; G06F 16/23; G06F 3/06; G06F 13/16

(52) U.S. Cl. CPC G06F 11/1004; G06F 16/2379; G06F 13/1668; G06F 3/0659; G06F 3/0689; G06F 3/0619

(57) ABSTRACT

A storage controller connected to a computer makes an IO request and has drive boxes connected to the storage controller. The storage controller configures a RAID group and the drive boxes store DB information including information for accessing the drive boxes connected to the storage controller and RAID group information of the RAID group configured by the storage controller. A first processor of a first drive box reads, if new data for updating old data stored in a first drive of the first drive box is received from the storage controller, the old data from the first drive and generates intermediate parity from the old data and the new data, transfers the intermediate parity to a second drive box storing old parity corresponding to the old data on the basis of the DB information and the RAID group information, and stores the new data in the first drive.

### CROSS-REFERENCE TO RELATED APPLICATION

The present application claims priority from Japanese application JP2019-080051, filed on Apr. 19, 2019, the contents of which is hereby incorporated by reference into this application.

### BACKGROUND OF THE INVENTION

### 1. Field of the Invention

The present invention relates to a parity calculation technique in a storage system.

### 2. Description of the Related Art

In a storage system, parity data which is redundant data is written in a drive using a redundant arrays of inexpensive disks (RAID) technique, which is a technique for protecting data in order to increase reliability of a system. If new data is written in a RAID group, since parity data constituting the RAID group is updated, the parity data is written in the drive.

A writing frequency of the parity data to the drive is high, and a load on a storage controller that performs a parity calculation process of generating parity increases. As a result, the performance of the storage controller is reduced.

In order to reduce the load on the storage controller and improve the processing performance of the storage system, a technique for performing a part of the parity calculation process on the drive side is disclosed in JP 2015-515033 W.

The storage system disclosed in JP 2015-515033 W includes a plurality of flash chips, a device controller connected to a plurality of flash chips, and a RAID controller connected to a plurality of flash packages. The RAID controller controls a plurality of flash packages including a first flash package storing old data and a second flash package storing old parity as a RAID group. A technique of executing, in a storage system, a step of generating first intermediate parity on the basis of old data stored in a first flash package and new data transmitted from a host computer through a first device controller of the first flash package, a step of transferring the first intermediate parity from the first flash package to a second flash package storing old parity, a step of generating first new parity on the basis of the first intermediate parity and the old parity through a second device controller of the second flash package, and a step of invalidating the old data through the first device controller after the first new parity is stored in a flash chip of the second flash package is disclosed.

In the storage system of JP 2015-515033 W, in order to transfer the intermediate parity generated by the first flash package to the second flash package, the RAID controller issues a read command to read the intermediate parity to the first flash package, reads the intermediate parity, issues an update write command to the second flash package, and transfers the intermediate parity.

In other words, a read process for the first flash package and a write process for the second flash package are necessary for the transfer of the intermediate parity, and the load on the RAID controller occurs.

The reason for this process is because there is no technique in which the flash package directly transfers data to other flash packages, and the flash package is a device that reads and writes data under the control of the RAID controller.

Further, it is considered that, since the RAID controller having information of the drive that constituting the RAID group has information of a transfer destination and a transfer source of the intermediate parity, the intervention of the system controller is inevitable in the parity calculation process.

As described above, in the technique disclosed in JP 2015-515033 W, the parity calculation process shifts from the system controller side to the flash package side, so that the processing load on the RAID controller (which is considered to correspond to the storage controller in terms of a function) side reduces.

However, the RAID controller needs to perform the read process for the first flash package and the write process for the second flash package for the intermediate parity, a part of the processing load of parity generation remains on the RAID controller side, and thus the reduction in the processing load on the RAID controller is considered to be insufficient.

### SUMMARY OF THE INVENTION

In this regard, it is an object of the present invention to provide a storage system with an improved processing capability by shifting the parity calculation process of the storage system that adopts the RAID technique to the drive housing side connected to the storage controller.

In order to achieve the above object, one aspect of a storage system of the present invention includes a storage controller connected to a computer that makes an IO request and a plurality of drive boxes connected to the storage controller. The storage controller configures a RAID group using some or all of the plurality of drive boxes. Each of the plurality of drive boxes includes a memory that stores DB information including information for accessing the plurality of drive boxes connected to the storage controller and RAID group information that is information of the RAID group configured by the storage controller, one or more drives, and a processing unit.

A first processing unit of a first drive box reads, if new data for updating old data stored in a first drive of the first drive box is received from the storage controller, the old data from the first drive and generates intermediate parity from the old data and the new data read from the first drive, transfers the generated intermediate parity to a second drive box among the plurality of drive boxes storing old parity corresponding to the old data on the basis of the DB information and the RAID group information, and stores the new data in the first drive.

A second processing unit of the second drive box generates new parity from the old parity and the intermediate parity transferred from the first drive box and stores the new parity in a second drive of the second drive box.

According to the present invention, the processing capacity of the storage system can be improved.

### BRIEF DESCRIPTION OF THE DRAWINGS

FIG. 1 is a configuration diagram illustrating an example of an information processing system according to an embodiment;

FIG. 2 is a hardware block diagram of a drive box according to an embodiment;

FIG. 3 is a diagram illustrating an example of an intermediate parity transfer operation according to an embodiment;

FIG. 4A is a diagram illustrating an example of RAID group information according to an embodiment;

FIG. 4B is a diagram illustrating an example of DB information according to an embodiment;

FIG. 5A is a diagram illustrating a storage status of data and parity in the case of RAID5 according to an embodiment;

FIG. 5B is a diagram illustrating a storage status of data and parity in the case of RAID5 according to an embodiment;

FIG. 6 is a write process sequence diagram according to an embodiment;

FIG. 7A is a diagram describing an operation of updating DB information when a configuration is changed according to an embodiment; and

FIG. 7B is a diagram describing an operation of updating RAID group information when a configuration is changed according to an embodiment.

### DETAILED DESCRIPTION OF THE PREFERRED EMBODIMENTS

An embodiment will be described with reference to the appended drawings. Note that an embodiment to be described below does not limit the invention related to claims set forth below, and all of elements described in an embodiment and combinations thereof are not intended to be essential for the solutions of the invention.

In the following description, there are cases in which information is described by an expression “AAA table,” but information may be expressed by any data structure. That is, the “AAA table” can be written as “AAA information” to indicate that information does not depend on a data structure.

Also, in the following description, a processor is typically a central processing unit (CPU). The processor may include a hardware circuitry that performs some or all of processes.

Also, in the following description, there are cases in which a “program” is described an entity of an operation, but since the program is executed by a CPU to perform a predetermined process while using a storage resource (for example, a memory) or the like appropriately, an actual entity of the process is a processor. Therefore, the process in which the program is described as the entity of the operation may be a process performed by a device including a processor. Further, a hardware circuitry that performs some or all of processes performed by the processor may be included.

A computer program may be installed in a device from a program source. The program source may be, for example, a program distribution server or a computer readable storage medium.

Further, according to an embodiment, for example, in a case in which a suffixes are added to reference numerals such as a host 10a and a host 10b, they have basically the same configuration, and in a case in which the same type of components are collectively described, suffixes are omitted such as a host 10.

### EMBODIMENT

<1. System Configuration>

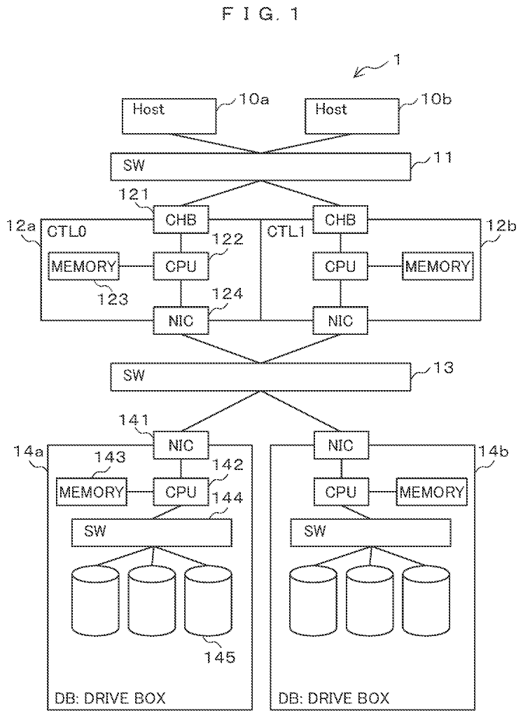

FIG. 1 is a configuration diagram illustrating an example of an information processing system according to the present embodiment.

An information processing system 1 includes one or more hosts 10, one or more switches 11 connected to the hosts 10, one or more storage controller 12 which are connected to the switches 11 and receive input output (IO) requests from the hosts 10 and process the IO requests, one or more switches 13 connected to one or more storage controller 12, and a plurality of drive boxes (also referred to as “drive housings”) 14 connected to the switches 13.

The storage controller 12 and a plurality of drive boxes 14 are connected to each other via a network including a local area network (LAN) or the Internet.

The host 10 is a computer device including information resources such as a central processing unit (CPU) and a memory, and is configured with, for example, an open system server, a cloud server, or the like. The host 10 is a computer that transmits an IO request, that is, a write command or a read command, to the storage controller 12 via a network in response to a user operation or a request from an installed program.

The storage controller 12 is a device in which necessary software for providing a function of a storage to the host 10 is installed. Usually, the storage controller 12 includes a plurality of redundant storage controllers 12a and 12b.

The storage controller 12 includes a CPU (processor) 122, a memory 123, a channel bus adapter 121 serving as a communication interface with the host 10, a NIC 124 serving as a communication interface with the drive box 14, and a bus connecting these units.

The CPU 122 is hardware that controls an operation of the entire storage controller 12. The CPU 122 reads/writes data from/to the corresponding drive box 14 in accordance with a read command or a write command given from the host 10.

The memory 123 includes, for example, a semiconductor memory such as a synchronous dynamic random access memory (SDRAM) and is used to store and retain necessary programs (including an operating system (OS)) and data. The memory 123 is a main memory of the CPU 122, and stores a program (a storage control program or the like) executed by the CPU 122, a management table, or the like referred to by the CPU 122, and is also used as a disk cache (a cache memory) of the storage controller 12.

Some or all of processes performed by the CPU 122 can be realized by dedicated hardware such as an application specific integrated circuit (ASIC) or a field-programmable gate array (FPGA).

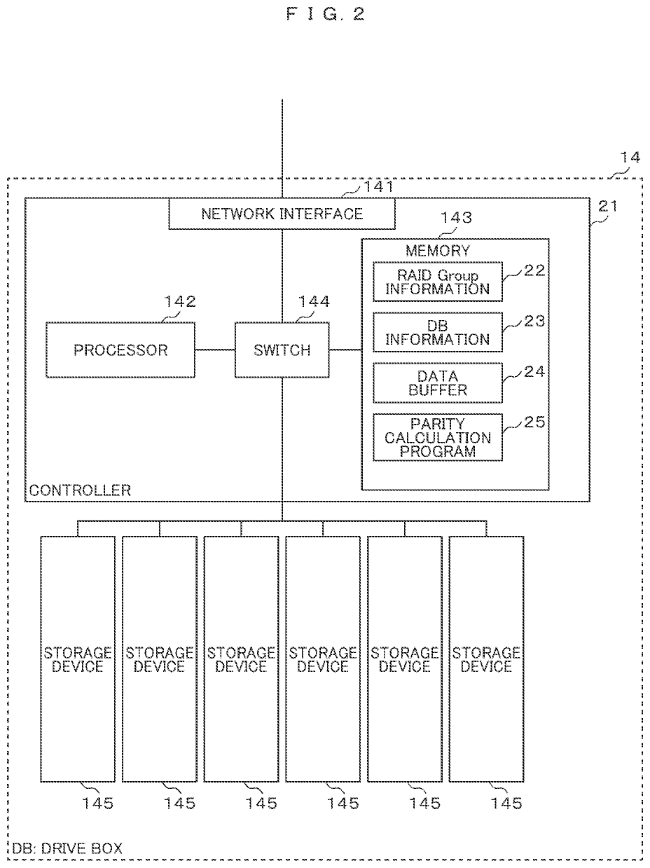

The drive box 14 is a device in which necessary software for providing the storage controller 12 with a function of a storage device for writing data to the drive and reading the data written in the drive is installed. The drive box will be described with reference to FIG. 2 in detail.

<2. Configuration of Drive Housing>

FIG. 2 is a configuration diagram of the drive box. The drive box 14 is a device in which necessary software for controlling the drive and providing a function of reading/writing from/to one or more drives which are storage devices from the outside is installed.

The drive box 14 includes a NIC (communication interface) 141 with a CPU (processor) 142, a memory 143, and a storage controller 12, a switch 144 for connecting the respective drives 145 to the CPU 142, and a bus for connecting these units.

The CPU 142 is hardware that controls the operation of the entire drive box 14. The CPU 142 controls writing/reading of data to/from the drive 145. Various kinds of functions are realized by executing a program stored in the memory 143 through the CPU 142. Therefore, although an actual processing entity is the CPU 142, in order to facilitate understanding of a process of each program, the description may proceed using a program as a subject. Some or all of processes performed by the CPU 142 can be realized by dedicated hardware such as an ASIC or an FPGA.

The memory 143 includes, for example, a semiconductor memory such as a synchronous dynamic random access memory (SDRAM) and is used to store and retain necessary programs (including an operating system (OS)) and data. The memory 143 is a main memory of the processor 142 and stores a program (a storage control program or the like) executed by the CPU 142, management information referred to by the CPU 142, or the like, and is also used as a data buffer 24 for temporarily storing data.

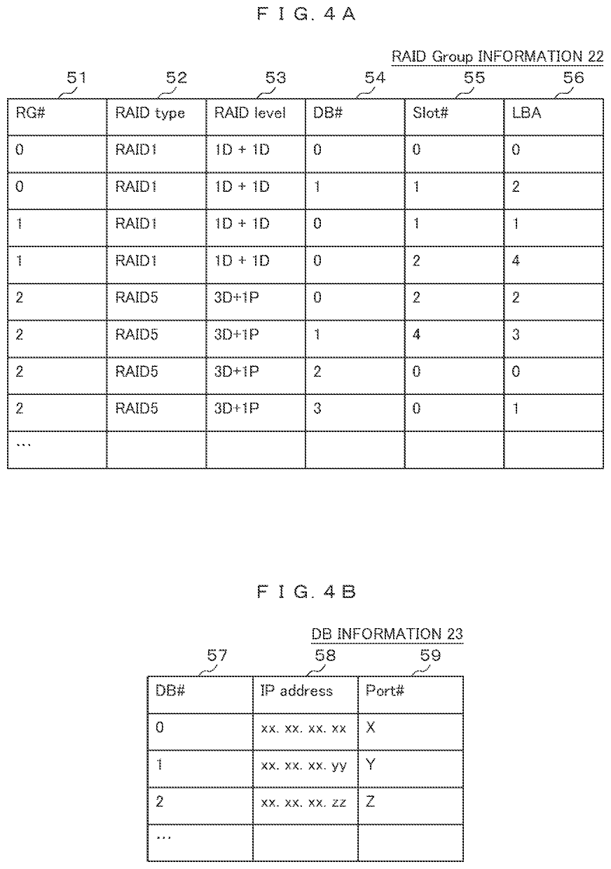

The management information stored in the memory 143 includes RAID group information 22 and DB information 23 for configuring a RAID group using some or all of a plurality of drive boxes. The RAID group information 22 will be described later with reference to FIG. 4A, and the DB information 23 will be described later with reference to FIG. 4B. A parity calculation program 25 for performing a parity calculation is stored in the memory 143.

One or more drives 145 which are storage devices are included in each drive box. The drive 145 may include a plurality of NAND flash memory chips in addition to a NAND flash memory (hereinafter referred to as “NAND”). The NAND includes a memory cell array. This memory cell array includes a large number of NAND blocks Bm−1. The blocks B0 to Bm−1 function as erase units. The block is also referred to as a “physical block” or an “erase block.”

The block includes a large number of pages (physical pages). In other words, each block includes pages P0 to Pn−1. In the NAND, data reading and data writing are executed in units of pages. Data erasing is executed in units of blocks.

The drive 145 conforms to NVM express (NVMe) or non-volatile memory host controller interface (NVMHCI) which are standards of a logical device interface for connecting a non-volatile storage medium. The drive 145 may be various kinds of drives such as a SATA and an FC other than NVMe.

The NIC 141 functions as an NVMe interface and transfers data between the drive boxes in accordance with an NVMe protocol without the intervention of the storage controller 12. Note that, it is not limited to the NVMe protocol, and a protocol in which a drive box of a data transfer source can be an initiator, a drive box of a data transfer destination can be a receiver, and data can be transferred between drives without control of other devices is desirable.

<Parity Calculation Process>

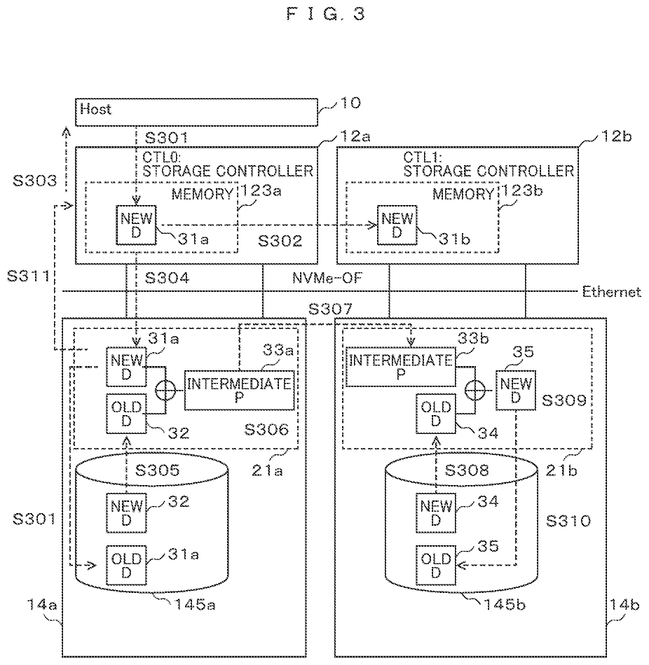

FIG. 3 is a diagram illustrating an example of an intermediate parity transfer operation according to an embodiment.

RAID5 is configured with the drive box 14a and the drive box 14b to secure data redundancy. In FIG. 3, only the drive 145a for storing data and the parity drive 145b for storing parity Data in RAID5 are Illustrated, and Other Data Drives are omitted. Other data drives operate basically in a similar manner to the data drive 145a.

In a state in which old data 32 is stored in the drive 145a of the drive box 14a and old parity 34 is stored in the drive 145b of the drive box 14b, new data is received from the host 10.

1. Reception of New Data

The storage controller 12a receives a write request of new data for updating the old data 32 from the host 10 (S301). At this time, the storage controller 12a transfers replicated data of new data 31a to the storage controller 12b, and duplicates the new data on the storage controller (S302). In a case in which the duplication is completed, the storage controller 12a reports the completion to the host 10 (S303).

2. Transfer of New Data to Drive Box

The storage controller 12a transfers the new data to the drive box 14a that stores the old data 32 (S304).

3. Intermediate Parity Generation

A controller 21a of the drive box 14a that has received the new data 31a reads the old data 32 from the drive 145a that stores the old data 32 (S305), and generates intermediate parity 33a from the new data 31a and the old data 32 (S306). The intermediate parity is calculated by (old data+new data). Note that the operator “+” indicates an exclusive OR.

4. Intermediate Parity Transfer

The controller 21a of the drive box 14a transfers the intermediate parity 33a generated from the new data 31a and the old data 32 to a controller 21b of the drive box 14b between the drive boxes (S307). The drive box 14a and the drive box 14b are connected by Ethernet (a registered trademark) and conform to the NVMe protocol, and thus the controller 21a of the drive box 14a can be an initiator, the controller 21b of the drive box 14b can be an receiver, and data can be transferred between drives without the intervention of storage controller 12.

5. New Parity Generation/Writing

Upon receives intermediate parity 33b from the controller 21a of the drive box 14a, the controller 21b of the drive box 14b reads the old parity 34 from the drive 145b (S308). The controller 21b generates new parity 35 from the intermediate parity 33b and the old parity 34 (S309), and writes the new parity in the drive 145b (S310). The controller 21a of the drive box 14a also writes new data in the drive 145a (S310). The new parity is calculated by (old parity+intermediate data). Note that the operator “+” indicates an exclusive OR.

If the new data is stored in the drive 145a and the new parity is stored in drive 145b, the controller 21a of the drive box 14a transmits a completion response to the storage controller 12 (S311).

The above operation is a basic operation for generating, in a case in which the storage controller 12 receives the new data from the host 10, generating the intermediate parity from the old data and the new data, generating the new parity from the intermediate parity and the old parity, and storing the new data and the new parity in the drive in the drive box. As described above, the storage controller 12 that has received the new data from the host 10 can control the write operation of the new data, the transfer operation of the intermediate parity, and the generation operation of the new parity through the process of the drive box 14 without performing the parity calculation process or the transfer process of the intermediate parity.

<Various Kinds of Management Information>

FIG. 4A is a diagram illustrating an example of the RAID group information according to an embodiment.

The RAID group information 22 is stored in the memory 143 in the controller 21 of the drive box 14 and corresponds to the RAID group information 22 of FIG. 2, and is information for managing the RAID group configured using some or all of a plurality of drive boxes.

RG #51 is an identification number identifying the RAID group. Note that RG #51 need not be necessarily a number as long as it is RAID group identification information identifying the RAID group and may be other information such as a symbol and a character.

RAID type 52 is a RAID configuration of the RAID group identified by RG #51. An introduction method according to an actual situation among RAID1, RAID2, RAID5, and the like while considering which one of reliability, speed, and budget (including drive use efficiency) is important and is stored in the RAID configuration.

RIAD level 53 is information indicating the RAID configuration corresponding to RAID type 52. For example, in the case of RG # “2” and RAID type “RAID5,” RAID level 53 is “3D+1P.”

DB #54 is an identifier identifying the DB information. The DB information will be described with reference to FIG. 4B.

Slot #55 indicates a slot number assigned to each drive, and LBA 56 stores a value of an LBA in the drive, that is, a logical block address which is address information indicating an address in each drive.

LBA #56 indicates a value of a logical block address.

FIG. 4B is a diagram illustrating an example of the DB information according to an embodiment. The DB information is information of the drive box that constitutes the RAID of FIG. 4A, and includes information to access the storage area (the drive box, the drive in the drive box, and the address in the drive) that constitutes each RAID group.

The DB information 23 is stored in the memory 143 in the controller 21 of the drive box 14, and corresponds to the DB information 23 of FIG. 2.

DB #57 corresponds to DB #54 of FIG. 4A and is an identifier identifying the drive box (DB) information. Note that DB #57 need not be necessarily a number as long as it is the drive box identification information identifying the drive box (DB) information and may be other information such as a symbol or a character.

IP address 58 indicates an IP address assigned to the drive box specified by DB #57, and Port #59 indicates a port number assigned to the drive box specified by DB #57 and is information necessary for accessing the drive box on Ethernet and transferring data.

<Write Operation>

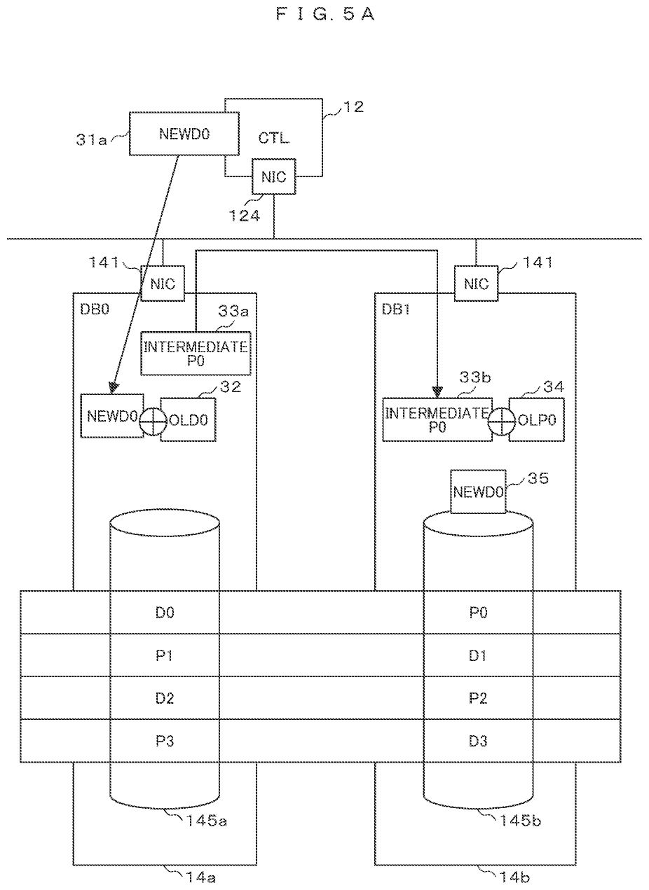

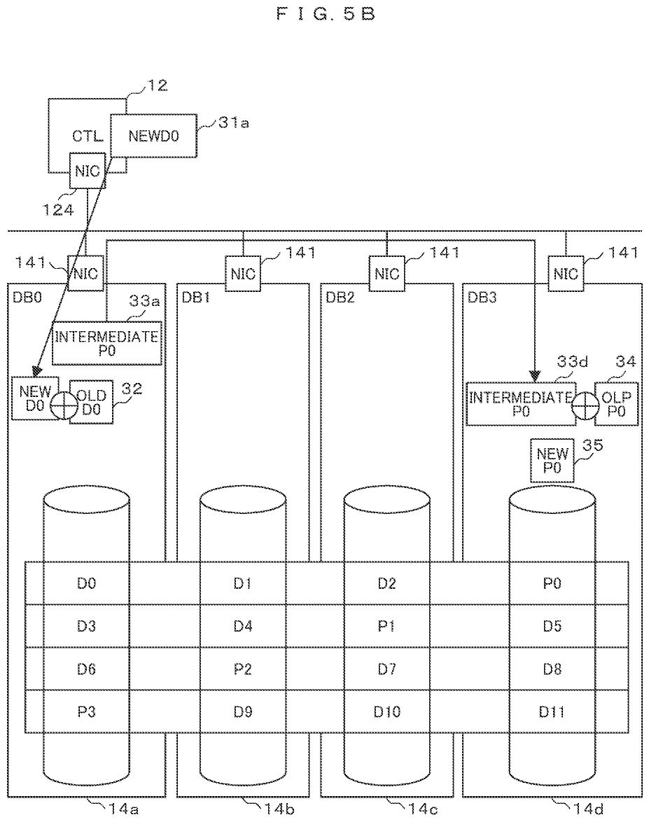

FIG. 5A is a diagram illustrating a storage status of the data and the parity in a case in which RAID type 52 of the RAID group information illustrated in FIG. 4A is “RAID5.” In FIG. 5A, similarly to FIG. 3, only the drive 145a for storing the data and the parity drive 145b for storing the parity data are illustrated, and other data drives are omitted.

The RAID group is configured with the drive 145a of the drive box 14a and the drive 145b of the drive box 14b. The RAID group of FIG. 5A is RAID5. Data “D0,” parity “P1,” data “D2,” and parity “P3” are stored in the drive 145a, and parity data “P0” of the data “D0” of the drive 145a, parity data “P2” of data “D2,” data “D1” corresponding to parity data “P1” of the drive 145a, and data “D3” corresponding to parity data “P3” of the drive 145a are stored in the drive 145b as illustrated in FIG. 5A.

If the storage controller 12 receives the new data 31a “new D0” which is update data for the data “D0,” the drive 145a performs the operation described with reference to FIG. 3.

In brief, the old data 32 “old D0” updated by new data “D0” is read from the drive 145a of the drive box 14a, and the intermediate parity 33a “intermediate P0” is generated from the new data 31a “new D0” and the old data 32 “old D0.”

The generated intermediate parity 33a “intermediate P0” is transferred from the drive box 14a to the drive box 14b constituting RAID5. The information specifying the drive box 14b or the drive 145b of the transfer destination and the old parity 34 “old P0” is the RAID group information of FIG. 4A and the DB information of FIG. 4B.

In the drive box 14b, the old parity 34 “old P0” is read from the drive 145b, and the new parity 35 “new P0” is generated from intermediate parity 33b “intermediate P0” and old parity 34 “old P0.” The intermediate parity 33a “intermediate P0” and the intermediate parity 33b “intermediate P0” are basically the same data.

The generated new parity 35 “new P0” is written in the drive 145b.

As described above, even in a case in which the RAID group is configured across a plurality of drive boxes, each drive box 14 manages the RAID group information and the DB information, and thus it is possible to detect the transfer destination of the intermediate parity generated from the new data and the old data on the basis of other drive boxes constituting the RAID group, drives, or the address information in the drives. In other words, the RAID group can be configured with an arbitrary combination of a plurality of drive boxes 14 connected to the storage controller 12, and the flexibility and the reliability of the system configuration can be improved.

Further, data is directly transferred between the drives without the intervention of the storage controller 12 by employing a protocol in which data can directly be transferred from the data transfer source to the transfer destination such as the NVMe protocol for the detected transfer destination, and thus the processing load of the storage controller can be reduced.

In other words, the write process can be performed at a high speed as the storage system by causing each drive to perform parity generation when the storage controller receives new data or the process of the storage controller in which data transfer is concentrated.

FIG. 5B is a diagram illustrating all data drives and parity drives in a case in which RAID type 52 of the RAID group information illustrated in FIG. 4A is “RAID5.”

As illustrated in FIG. 5B, in each of the drives 145 in the drive box 14, the RAID group is configured with three drives storing data constituting the RAID group and one drive storing the parity data of the data stored in the three drives, that is, with 3D+1P.

The operation of receiving the new data 31a “new D0” from the storage controller 12, generating the parity, and storing the new data “new D0” and the new parity “new P0” in the drive 145 in each drive box is basically the same as the operation illustrated in FIG. 5A.

In other words, the old data 32 “old D0” updated by the new data “D0” from the drive 145a of the drive box 14a, and the intermediate parity 33a “intermediate P0” is generated from the new data 31a “new D0” and the old data 32 “old D0.”

The generated intermediate parity 33a “intermediate P0” constitutes RAID5 from the drive box 14a and is transferred to the drive box 14d storing the old parity 34 “old P0” corresponding to the old data 32 “old D0.” The information specifying the drive box 14d of the transfer destination, the drive 145d, and the old parity 34 “old P0” includes the RAID group information of FIG. 4A and the DB information of FIG. 4B.

In the drive box 14d, the old parity 34 “old P0” is read from the drive 145d, and the new parity 35 “new P0” is generated from the intermediate parity 33d “intermediate P0” and the old parity 34 “old P0.” Note that, the intermediate parity 33a “intermediate P0” and the intermediate parity 33d “intermediate P0” are basically the same data.

The generated new parity 35 “new P0” is written in the drive 145d.

As described above, even in a case in which the RAID group is configured across a plurality of drive boxes, each drive box 14 manages the RAID group information and the DB information, and thus it is possible to detect the transfer destination of the intermediate parity generated from the new data and the old data on the basis of other drive boxes constituting the RAID group, drives, or the address information in the drives. In other words, the RAID group can be configured with an arbitrary combination of a plurality of drive boxes 14 connected to the storage controller 12, and the flexibility and the reliability of the system configuration can be improved. Further, data is directly transferred between the drives without the intervention of the storage controller by employing a protocol in which data can directly be transferred from the data transfer source to the transfer destination such as the NVMe protocol for the detected transfer destination, and thus the processing load of the storage controller can be reduced.

In other words, the write process can be performed at a high speed as the storage system by causing each drive to perform parity generation when the storage controller receives new data or the process of the storage controller in which data transfer is concentrated.

<Operation Sequence of Write Process>

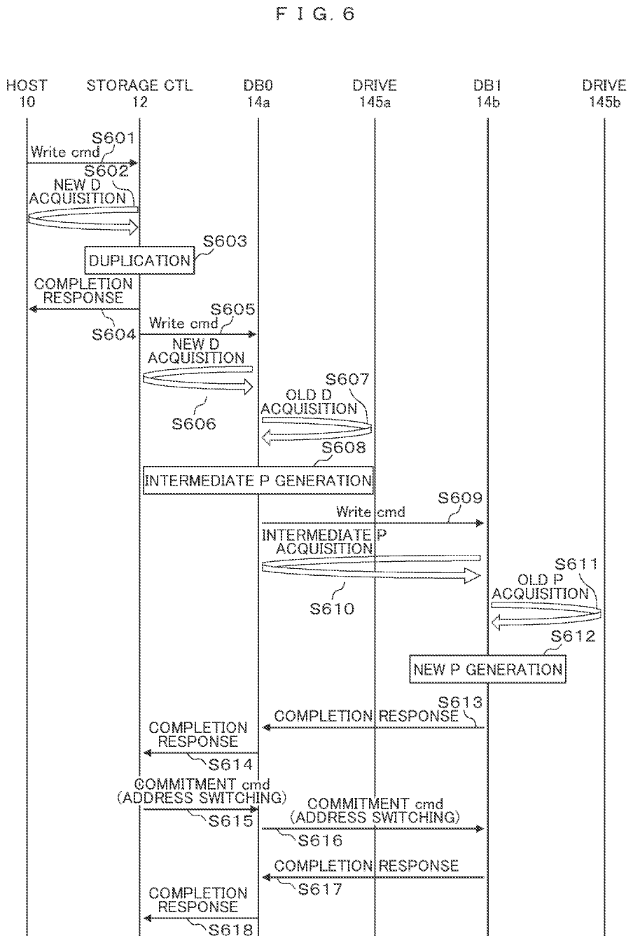

FIG. 6 is a write process sequence diagram according to an embodiment.

FIG. 6 illustrates a process sequence of the host 10, the storage controller 12, the drive box 14a, the drive 145a, the drive box 14b, and the drive 145b. In the example illustrated in FIG. 6, RAID5 is formed by the drive 145a of the drive box 14a and the drive 145b of the drive box 14b. Here, for the sake of simplicity, only the drive 145a for storing the data and the parity drive 145b for storing the parity data are illustrated, and other data drives are omitted.

In this sequence diagram, since the drive is assumed to be configured with a NAND, writing of data is of a recordable type, and thus even in a case in which data stored in the drive is updated by the write data, the new data is stored at an address different from that of the old data.

First, in the host 10, the new data for updating the old data stored in the drive 145a is generated, and the write command to store the new data in the storage system is transmitted to storage controller 12 (S601). The storage controller 12 acquires the new data from the host 10 in accordance with the write command (S602). The storage controller transfers the new data to other redundant storage controllers to duplicate the new data (S603). The duplication operation is an operation corresponding to step S302 of FIG. 3.

If the duplication of the new data is completed, the storage controller 12 that has received the write command transmits a completion response to the host 10 (S604).

The storage controller 12 transmits the write command to the drive box 14a storing the old data updated by the new data (S605), and the drive box 14a that has received the write command acquires the new data (S606).

The controller of the drive box 14a that has acquired the new data acquires the old data updated by the new data from the drive 145a (S607), and generates the intermediate parity from the new data and the old data (S608). Since the drive 145a is a recordable device configured with a NAND, the new data is stored in the drive 145a at an address different from the storage position of the old data.

In order to transfer the generated intermediate parity, the drive box 14a transmits the write command to the other drive boxes 14b constituting the RAID group with reference to the RAID group information 22 and the DB information 23 stored in the memory 143 (S609). In the write command, in addition to the drive box 14b, the drive 145b and the address in the drive are designated as the transmission destination. The write command is transferred between the drive boxes on Ethernet in accordance with a protocol that designates the transfer source and the transfer destination address such as the NVMe.

The drive box 14b acquires the intermediate parity from the write command transferred from the drive box 14a (S610), and reads the old parity from the same RAID group as the old data from the drive 145d (S611). The address of the old parity is acquired from the address of the old data, the RAID group information, and the DB information.

The drive box 14b calculates the new parity from the intermediate parity and the old parity (S612). Since the drive 145b is a recordable device configured with a NAND, the calculated new parity is stored in the drive 145b at an address different from the storage position of the old parity.

The drive box 14b transmits the completion response to the drive box 14a (S613). The drive box 14a that has received the completion response transmits the completion response to the storage controller 12 (S614).

Upon receiving the completion response, the storage controller 12 transmits a commitment command to switch the reference destination of the logical address from the physical address at which the old data is stored to the physical address at which the new data is stored to the drive box 14a (S615).

Upon receiving the commitment command, the drive box 14a switches the reference destination of the logical address corresponding to the data from the physical address at which the old data is stored to the physical address at which the new data is stored, and transmits the commitment command to the other drive boxes 14b that constitute the RAID group (S616).

Upon receiving the commitment command, the drive box 14b switches the reference destination of the logical address corresponding to the parity from the physical address at which the old parity is stored to the physical address at which the new parity is stored, and transmits the completion response to the drive box 14a (S617). Upon receiving the completion response from the drive box 14b, the drive box 14a transmits the completion response to the storage controller (S168).

As described above, after the storage controller receives the completion report indicating that the new data and the new parity have been stored in the drive from each drive box, the correspondence relation between the logical address and the physical address is switched for each drive box, and thus there is a timing at which both the old data and the new data are stored in the drive 145a at the same time, and both the old parity and the new parity are stored in the drive 145b at the same time. Therefore, the storage system can receive the write command from the host and generate the parity, and even when a system failure such as a power failure occurs while the new data or the new parity is being stored in the drive, no data is lost, and thus the write process can be continued using the old data, the old parity, and the new data after the system is widespread.

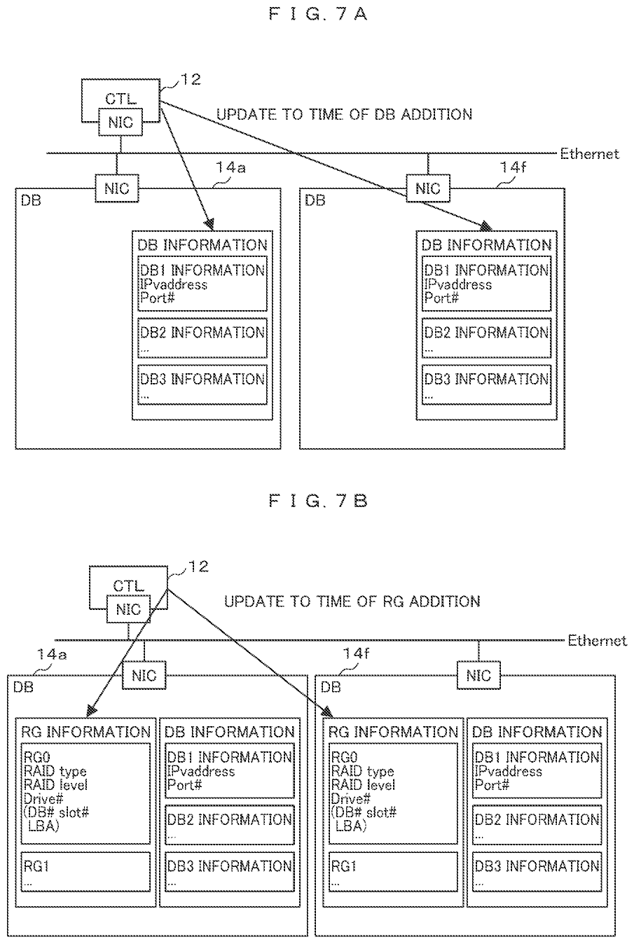

FIGS. 7A and 7B are diagrams illustrating operations of updating the RAID group information 22 and the DB information 23 in a case in which a new drive box is added to the storage controller 12.

As illustrated in FIG. 7A, if the drive box is added, the DB information of the drive box 14f added to the drive box 14a already connected to the storage controller 12 is transferred from the storage controller 12. Further, the DB information of the drive box 14a already connected to the storage controller is transferred to the added drive box 14f, and the DB information of all the drive boxes is stored in the memory of all the drive boxes connected to the storage controller 12. Even in a case in which the number of drive boxes is decreased, the storage controller transfers the DB information to the remaining drive boxes.

Also, as illustrated in FIG. 7B, in a case in which the RAID group is added or changed, that is, in a case in which the RAID configuration is changed, the RAID group information representing the changed RAID configuration is transferred from the storage controller 12 to each drive box 14 and stored in the memory of each drive box.

As described above, even in a case in which the number of drive boxes is increased or decreased, the DB information of the drive box connected to the storage controller is stored in each drive box. Also, even in a case in which the RAID configuration is changed, the RAID group information is stored in each drive box connected to the storage controller. Accordingly, even in a case in which the number of drive boxes is increased or decreased or the RAID configuration is changed, each drive can store the latest RAID group information and the latest DB information and transmit the intermediate parity to the transfer destination such as an appropriate drive box.

Further, the present embodiment can be applied to a remote copy function of remotely copying redundant data in addition to the RAID group, and thus the processing of the storage controller for performing the remote copy can be reduced.

As described above, according to the storage system according to the present embodiment, it is possible to reduce the processing load of the storage controller and improve the processing capacity of the storage system by shifting the parity calculation process of the storage system adopting the RAID technique to the drive housing side connected to the storage controller.

As described above, even in a case in which the RAID group is configured across a plurality of drive boxes, each drive box 14 manages the RAID group information and the DB information, and thus it is possible to detect the transfer destination of the intermediate parity generated from the new data and the old data on the basis of other drive boxes constituting the RAID group, drives, or the address information in the drives. In other words, the RAID group can be configured with an arbitrary combination of a plurality of drive boxes 14 connected to the storage controller 12, and the flexibility and the reliability of the system configuration can be improved.

Further, data is directly transferred between the drives without the intervention of the storage controller 12 by employing a protocol in which data can directly be transferred from the data transfer source to the transfer destination such as the NVMe protocol for the detected transfer destination, and thus the processing load of the storage controller can be reduced.

In other words, the write process can be performed at a high speed as the storage system by causing each drive to perform parity generation when the storage controller receives new data or the process of the storage controller in which data transfer is concentrated.

What is claimed is:

1. A storage system, comprising:
a storage controller connected to a computer that makes an IO request; and
a plurality of drive boxes connected to the storage controller,
wherein the storage controller configures a RAID group using some or all of the plurality of drive boxes,
each of the plurality of drive boxes includes
a memory that stores DB information including information for accessing the plurality of drive boxes connected to the storage controller and RAID group information that is information of the RAID group configured by the storage controller, and
one or more drives,
a first drive box among the plurality of drive boxes includes a first processing unit that
reads, if new data for updating old data stored in a first drive of the first drive box is received from the storage controller, the old data from the first drive and generates intermediate parity from the old data and the new data read from the first drive,
transfers the generated intermediate parity to a second drive box among the plurality of drive boxes storing old parity corresponding to the old data on the basis of the DB information and the RAID group information, and
stores the new data in the first drive, and
the second drive box includes a second processing unit that generates new parity from the old parity and the intermediate parity transferred from the first drive box and stores the new parity in a second drive of the second drive box.

2. The storage system according to claim 1, wherein the DB information includes drive box identification information specifying each of the plurality of drive boxes, an IP address assigned to each of the plurality of drive boxes corresponding to the drive box identification information, and a port number assigned to each of the plurality of drive boxes.

3. The storage system according to claim 2, wherein the RAID group information includes RAID group identification information identifying a RAID group, a RAID type indicating a RAID configuration of a RAID group corresponding to the RAID group identification information, the drive box identification information specifying the drive box, a slot number assigned to each drive of the drive box, and address information indicating an address in each drive.

4. The storage system according to claim 3, wherein transfer of the intermediate parity from the first drive box to the second drive box is performed in accordance with an NVMe protocol.

5. The storage system according to claim 4, wherein the second processing unit of the second drive box transmits a first completion response to the first processing unit of the first drive box if the new parity is stored in the second drive,
the first processing unit of the first drive box receives the first completion response and transmits a second completion response to the storage controller if the new data is stored in the first drive,
the storage controller that has received the second completion response transmits a commitment command to the first and second drive boxes,
the first processing unit of the first drive box that has received the commitment command switches a reference destination from the old data stored in the first drive to the new data, and
the second processing unit of the second drive box that has received the commitment command switches a reference destination from the old parity stored in the second drive to the new parity.

6. A drive box installed in a storage system including a storage controller that is connected to a computer that makes an IO request and configures a RAID group with a plurality of drive boxes,
wherein a first drive box among the plurality of drive boxes includes
a memory that stores DB information including information for accessing the plurality of drive boxes connected to the storage controller and RAID group information that is information of the RAID group configured by the storage controller,
one or more drives, and
a first processing unit that
reads, if new data for updating old data stored in a first drive of the first drive box is received from the storage controller, the old data from the first drive and generates intermediate parity from the old data and the new data read from the first drive,
transfers the generated intermediate parity to a second drive box among the plurality of drive boxes storing old parity corresponding to the old data on the basis of the DB information and the RAID group information, and
stores the new data in the first drive.

7. The drive box according to claim 6, wherein the DB information includes drive box identification information specifying each of the plurality of drive boxes, an IP address assigned to each of the plurality of drive boxes corresponding to the drive box identification information, and a port number assigned to each of the plurality of drive boxes.

8. The drive box according to claim 7, wherein the RAID group information includes RAID group identification information identifying a RAID group, a RAID type indicating a RAID configuration of a RAID group corresponding to the RAID group identification information, the drive box identification information specifying the drive box, a slot number assigned to each drive of the drive box, and address information indicating an address in each drive.

9. The drive box according to claim 8, wherein transfer of the intermediate parity from the first drive box to the second drive box is performed in accordance with an NVMe protocol.

10. The drive box according to claim 9, wherein the first processing unit of the first drive box transmits a second completion response to the storage controller if the new data is stored in the first drive, and
the first processing unit of the first drive box switches a reference destination from the old data stored in the first drive to the new data if a commitment command is received from the storage controller that has received the second completion response.

11. A parity calculation method of a storage system including a storage controller that is connected to a computer that makes an IO request and a plurality of drive boxes and configures a RAID group using some or all of the plurality of drive boxes, the parity calculation method comprising:
reading, by a first drive box among the plurality of drive boxes, if new data for updating old data stored in a first drive of the first drive box is received from the storage controller, the old data from the first drive and generating intermediate parity from the old data and the new data read from the first drive;
transferring, by the first drive box among the plurality of drive boxes, the generated intermediate parity to a second drive box among the plurality of drive boxes storing old parity corresponding to the old data on the basis of DB information including information for accessing the plurality of drive boxes connected to the storage controller and RAID group information which is information of the RAID group configured by the storage controller;
storing, by the first drive box among the plurality of drive boxes, the new data in the first drive; and
generating, by the second drive box, new parity from the old parity and intermediate parity transferred from the first drive box and storing the new parity in a second drive of the second drive box.

12. The parity calculation method according to claim 11, wherein a second processing unit of the second drive box among the plurality of drive boxes transmits a first completion response to a first processing unit of the first drive box if the new parity is stored in the second drive,
the first processing unit of the first drive box receives the first completion response and transmits a second completion response to the storage controller if the new data is stored in the first drive,
the storage controller that has received the second completion response transmits a commitment command to the first and second drive boxes,
the first processing unit of the first drive box that has received the commitment command switches a reference destination from the old data stored in the first drive to the new data, and
the second processing unit of the second drive box that has received the commitment command switches a reference destination from the old parity stored in the second drive to the new parity.
